(19) United States
(12) Patent Application Publication
(10) Pub. No.: US 2026/0146889 A1
(43) Pub. Date: May 28, 2026

(54) Ambient Light Sensor

(71) Applicant: SENSORTEK TECHNOLOGY CORP., Hsinchu City (TW)

(72) Inventor: Yu-Min Lin, Hsinchu County (TW)

(21) Appl. No.: 19/341,986

(22) Filed: Sep. 26, 2025

Related U.S. Application Data
(60) Provisional application No. 63/699,173, filed on Sep. 26, 2024.

(51) Int. Cl. G01J 1/42; G01J 1/02; G01J 1/04

(52) U.S. Cl. CPC G01J 1/4204; G01J 1/029; G01J 1/0418; G01J 1/0492

(57) ABSTRACT

An ambient light sensor comprising at least three main channel sensing units and at least one cooperative channel sensing unit. Each main channel sensing unit includes a filter and a photosensitive element, with the filter positioned on the light receiving path of the photosensitive element, wherein the filter of at least one main channel sensing unit is an absorptive filter. Each cooperative channel sensing unit includes a filter and a photosensitive element, with the filter positioned on the light receiving path of the photosensitive element, wherein the filter of at least one cooperative channel sensing unit is an interference filter. This configuration effectively controls the error range of spectral reproduction results in ambient light sensor products affected by process variations, thereby improving product yield.

### FIELD OF THE INVENTION

The present application relates to an ambient light sensor for sensing intensity of ambient light, particularly a multi-channel ambient light sensor with an absorptive filter.

### BACKGROUND OF THE INVENTION

Light sensors implemented by light sensing technology are widely used in various applications, in which, ambient light sensors (ALS) may be used in electronic products for sensing the intensity of ambient light to adjust the brightness of the display screen, thereby improving ease of use and extending battery life.

In basic applications of ambient light sensors, to identify types of ambient light sources, multi-channel sensing units are typically used to sense different wavelength components in the ambient light, attempting to reproduce spectral characteristics approximated to the CIE XYZ color space defined by the International Commission on Illumination (CIE). As shown in FIG. 1, since the multi-channel sensing units need to sense lights within different wavelengths, in existing ambient light sensors 9, an interference filter 91 is typically formed by stacking a plurality of interference thin films made of dielectric materials with different refractive indices, and disposed on the light-receiving path of photosensitive elements 92 such as photodiodes, serving as a multi-channel sensing unit. This is because the interference filter 91 formed by stacking of the interference thin films may easily be designed to have specific spectral response characteristics by changing parameters of the interference thin films, such as material, thickness, and layer number.

Please refer to FIG. 2A to FIG. 2G, which show the spectral reproduction results of the existing ambient light sensor 9 for standard test light sources, such as CWF, U35, U30, D65, A, HZ, and LED-B4. The solid lines represent the actual light intensity emitted by these standard light sources, while the dashed lines represent the spectrum characteristic curves reproduced by merging the light intensity responses of the multi-channel sensing units. It is noted that the reproduced spectrum characteristic curves may contain jitter due to insufficient resolution, and may not necessarily match the actual light intensity curves. However, as long as there is a sufficient difference from the reproduction results of other test light sources, it is sufficient to distinguish and identify the types of ambient light sources. Taking this example, if the root-mean-square error (RMSE) is calculated between the reproduced spectrum characteristic curves and the actual light intensity curves under each standard test light source, the calculation result is approximately 2.22, which is sufficient to distinguish the aforementioned seven standard light sources.

However, during producing the interference filter 91, variations in the thickness of the interference film may easily cause wavelength shifts in the spectral responses or intensity shifts in the light transmittances, leading to the spectral reproduction results of some products differing from the original design during mass production. For example, assuming that the spectral response of the interference filter 91 has a wavelength response shift of ±5 nm and a light transmittance shift of ±5%, a simulation with a production volume of 1 million units may yield the root mean square error distribution results shown in FIG. 3, in which the average value exceeds 3.5, which is significantly different from the 2.22 estimated in the original design, directly causing occurrence of yield problems for the ambient light sensor 9 produced according to this design.

In view of above problems, there is a need to improve existing ambient light sensors. However, it should be noted that cost requirements of the light sensors are very strict. If the improvement scheme may improve the accuracy of spectral reproduction but requires too many additional components, it is still not marketable in the art. For example, more sensing units may be added as compensation channels for process offset, but this approach will greatly increase the overall design and production cost of the ambient light sensor obviously.

### SUMMARY OF THE INVENTION

An objective of the present application is to provide an ambient light sensor, by configuring an absorptive filter as a filter for a main channel sensing unit, an error range of a spectral reproduction result of the ambient light sensor product affected by process variations may be controlled effectively, thereby improving the product yield to be better than the prior art.

The present application reveals an ambient light sensor, comprising at least three main channel sensing units and at least one cooperative channel sensing unit, the at least three main channel sensing units each comprising a first filter and a first photosensitive element, the first filter disposed on a light-receiving path of the first photosensitive element, wherein the first filter of at least one of the at least three main channel sensing units is an absorptive filter; each of the at least one cooperative channel sensing unit comprising a second filter and a second photosensitive element, the second filter disposed on a light-receiving path of the second photosensitive element, wherein the second filter of at least one of the at least one cooperative channel sensing unit is an interference filter.

Preferably, the at least three main channel sensing units comprise three first filters of three of the at least three main channel sensing units that are absorptive filters.

### BRIEF DESCRIPTION OF DRAWINGS

FIG. 1: A schematic structure diagram showing the existing ambient light sensor according to the prior art;

FIG. 2A to FIG. 2G: schematic diagrams showing the spectral reproduction results of the existing ambient light sensor for the seven standard test light source according to the prior art;

FIG. 3: A diagram showing the root mean square error distribution of the existing ambient light sensors under process variation conditions according to the prior art;

FIG. 4: A schematic structure diagram showing the ambient light sensor according to the first embodiment of the present application;

FIG. 5A to FIG. 5G: schematic diagrams showing the spectral reproduction results of the ambient light sensor for the seven standard test light source according to the first embodiment of the present application;

FIG. 6: A diagram showing the root mean square error distribution of existing ambient light sensors under process variation conditions according to the first embodiment of the present application;

FIG. 7: A schematic structure diagram showing the ambient light sensor according to a change state from the first embodiment of the present application;

FIG. 8A to FIG. 8G: schematic diagrams showing the spectral reproduction results of the ambient light sensor for the seven standard test light source according to the second embodiment of the present application;

FIG. 9: A schematic structure diagram showing the ambient light sensor according to another embodiment of the present application;

FIG. 10: A schematic diagram showing the root mean square error distribution of the existing ambient light sensors under harsh process variation conditions according to the prior art; and

FIG. 11: A schematic diagram showing the root mean square error distribution of the ambient light sensors under harsh process variation conditions according to the first embodiment of the present application.

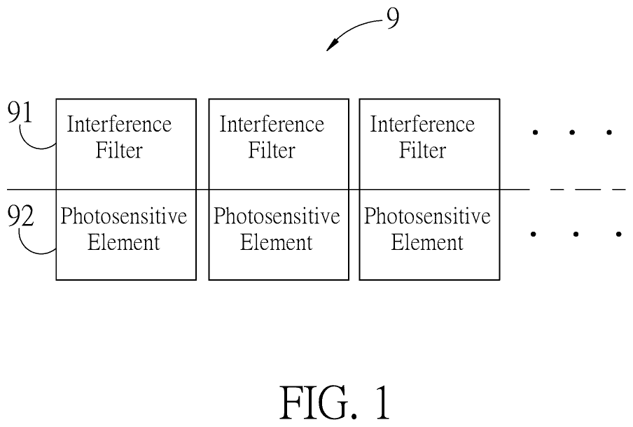

### DETAILED DESCRIPTION OF THE INVENTION

Certain terms are used in the specification and claims to refer to specific elements; however, those skilled in the art should understand that manufacturers may use different terms to refer to the same element, moreover, the specification and claims do not distinguish elements based on the difference in terms, but rather on the technical differences in the elements overall.

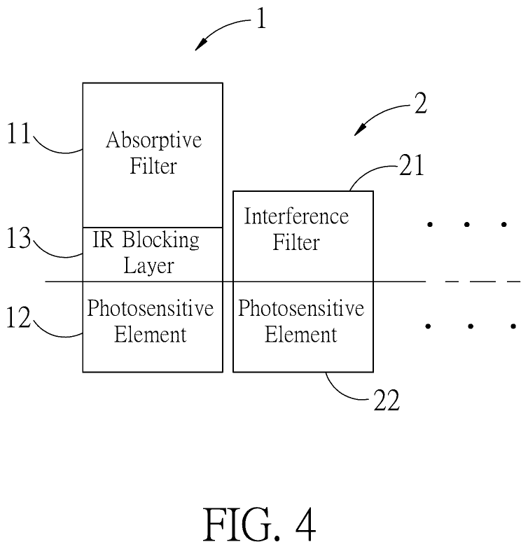

Please refer to FIG. 4, the ambient light sensor according to the first embodiment of the present application comprises at least three main channel sensing units 1 and at least one cooperative channel sensing unit 2. Each of the at least three main channel sensing units 1 comprises a filter 11 and a photosensitive element 12, where the filter 11 is disposed on a light-receiving path of the photosensitive element 12. In this embodiment, the filter 11 is used as an absorptive filter, and the basic principle thereof is to absorb light within a specific (color) wavelength and to transmit other light within other wavelengths. In the art of micro light sensors, photoresist materials may be used to filter light within a specific wavelength, and processed to form on the wafer surface, thereby, the photoresist materials may be used to form the absorptive filter. In which, at least three of the at least three main channel sensing units 1 are used to reproduce a spectral characteristic approximate to CIE XYZ color space, requiring at least three different intensity sensing results in different wavelength ranges. Thus, the filters 11 of the at least three main channel sensing units 1 absorbs different lights within different wavelengths for the photosensitive elements 12 to sense different visible lights within different wavelength ranges from each other.

By combining at least three intensity sensing results of visible lights from the at least three main channel sensing units 1, the spectral characteristic may be reproduced to be approximate to CIE XYZ color space, used to estimate color information for subsequent application of light source type identification or color temperature calculation. Nevertheless, the absorptive filter formed by the photoresist materials has limited spectral adjustability, which is determined by the properties of the photoresist material itself. While the overlapped areas in the visible light ranges are too large, causing the reproduction of the spectral characteristic to have insufficient resolution, furthermore, since wafers have higher transmittance for infrared light, and absorptive filters made of materials such as photoresist materials do not efficiently absorb infrared light, when the filter 11 within one of the at least three main channel sensing unit 1 is used as an absorptive filter, it is usually combined with an infrared light blocking layer 13 (IR Blocking Filter) to filter out the infrared component of the sensed light. The infrared light blocking layer 13 is also disposed on the light-receiving path of the photosensitive element 12 to prevent the photosensitive element 12 from interference from the infrared light in sensing of visible lights within different wavelength ranges, but causing the result that the at least three main channel sensing units 1 are almost unable to sense the intensity of light within the infrared light range (approximately within 760 nm to 1000 nm).

Thereby, the ambient light sensor according to the first embodiment of the present application further comprises the at least one cooperative channel sensing unit 2 comprising a filter 21 and a photosensitive element 22, where the filter 21 is disposed on a light-receiving path of the photosensitive element 22. In this embodiment, the filter 21 of the at least one cooperative channel sensing unit 2 may be used as an interference filter, which isn't relied on “absorbing” light energy, but selectively reflects or transmits light within the specific wavelengths by using the wave properties and the interference phenomenon of light. Specifically, the filter 21 is a thin film structure formed by alternatively stacking a plurality of layers of dielectric materials on an optical substrate (such as glass). The interference filter may further be formed by a stacked thin film structure of stacking a plurality of interference thin films with Fabry-Perot Interferometer characteristics. Since the interference filter may be designed to have specific spectral response characteristics by changing the parameters of the interference thin films, such as material, thickness, and layer number. Thereby, the photosensitive element 22 of the at least one cooperative channel sensing unit 2 may be configured to match the filter 21 for a specific wavelength range to improve the resolution in the wave band with insufficient resolution of the at least three main channel sensing units 1.

The aforementioned photosensitive elements 12 and 22 may sense the light passing through the aforementioned filters 11 and 21 to obtain an optical signal value. Generally, the ambient light sensor may further comprise a computing circuit to receive the optical signal value and calculate an ambient light intensity value based on the optical signal value. However, this application does not focus on the relevant technical content of the computing circuit, which may be disclosed in incorporated by reference, the applicant's prior U.S. Pat. No. 12,339,161B2.

In this first embodiment, the at least one cooperative channel sensing unit 2 may further comprise a visible light channel corresponding to a wavelength of approximate to 453 nm and two infrared light channels corresponding to two infrared wavelengths of approximate to 766 nm and 800 nm. Each of the mentioned three channels may be configured using an interference filter, thereby compensating for the insufficient visible light resolution of the at least three main channel sensing units 1 corresponding to a wavelength of approximate to 453 nm (possibly due to excessive overlapping area between two of the at least three main channel sensing units 1 at this wavelength) and the problem that the at least three main channel sensing units 1 may have difficulty in sensing light intensity in the infrared range.

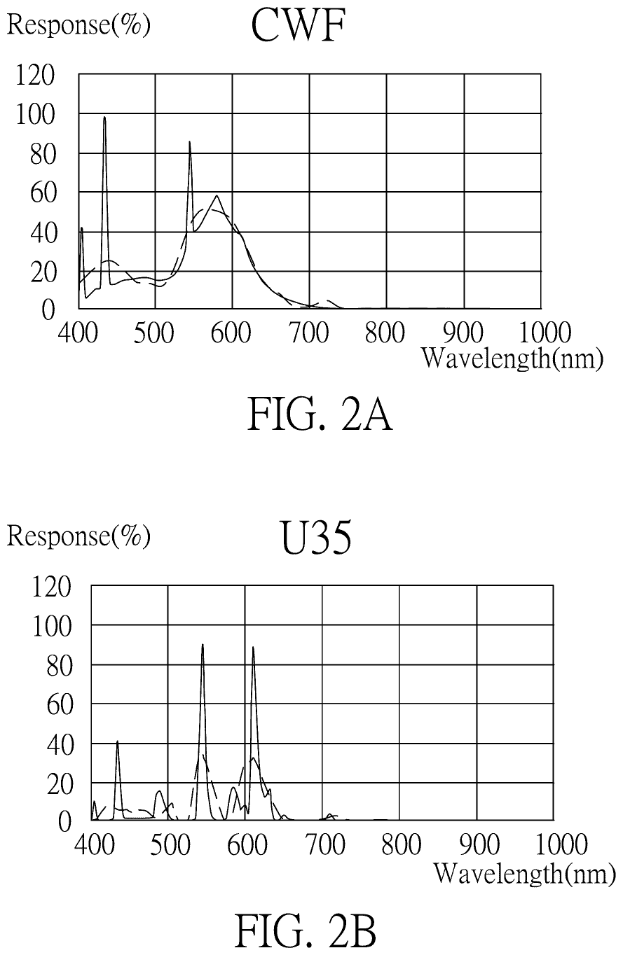

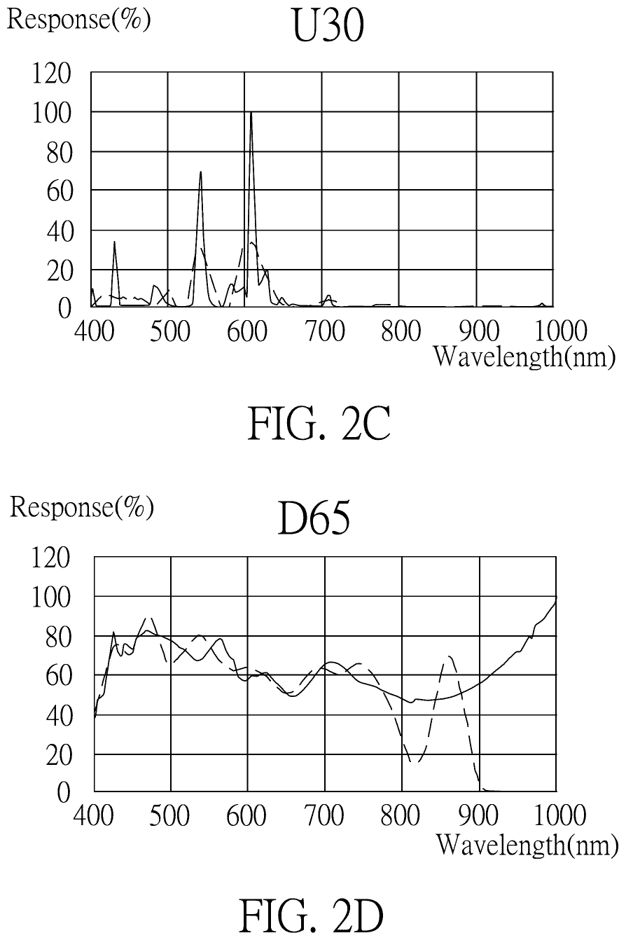

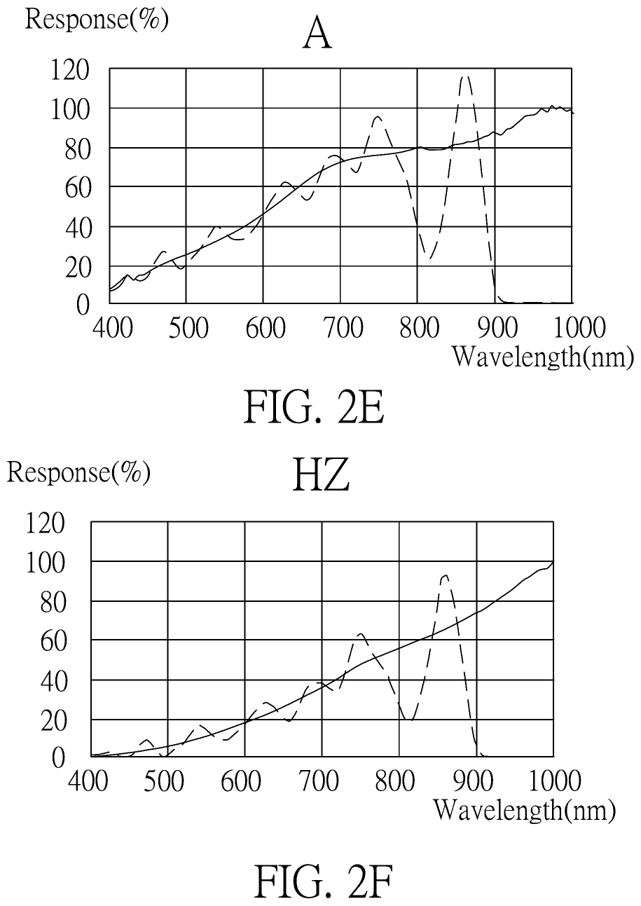

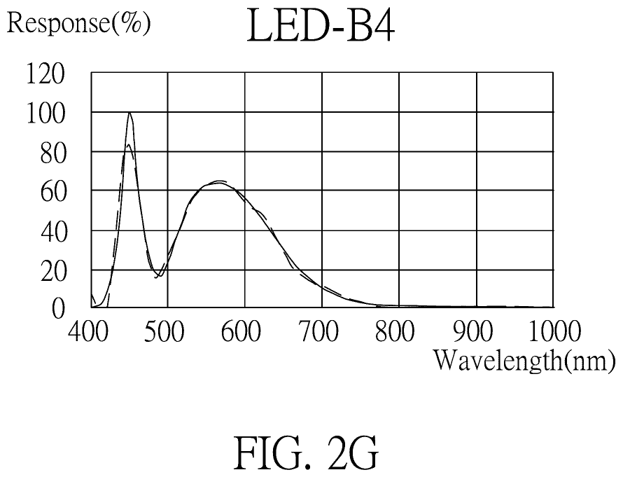

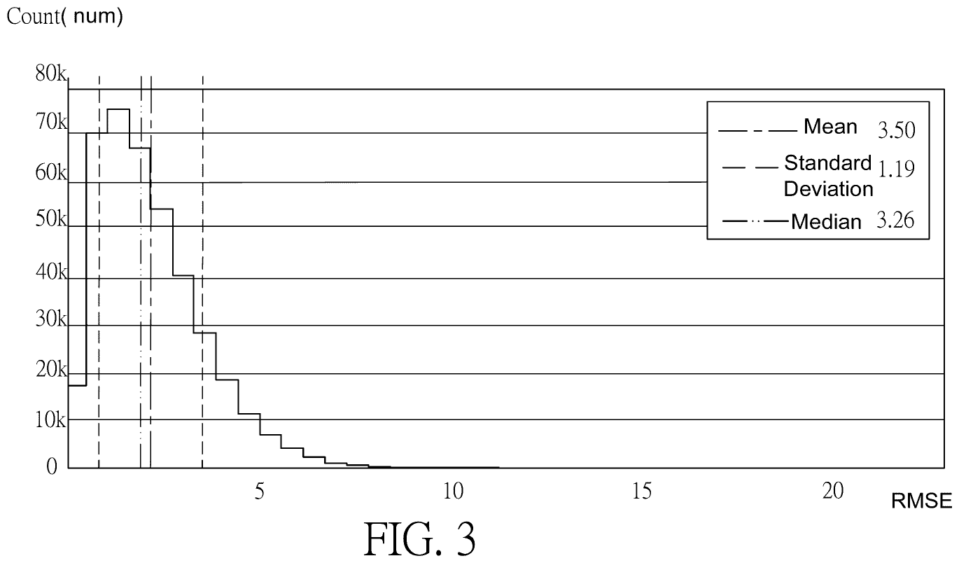

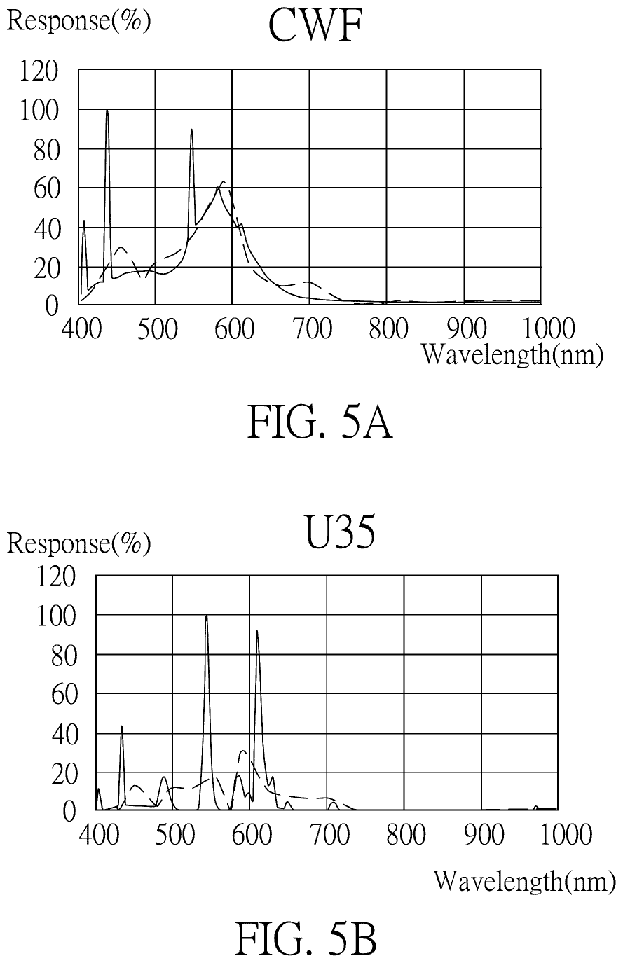

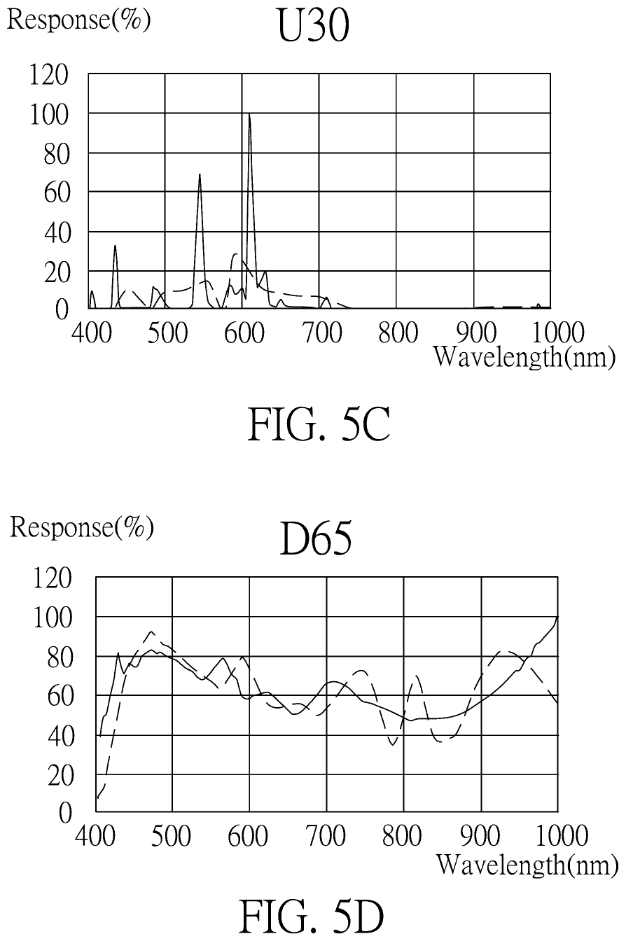

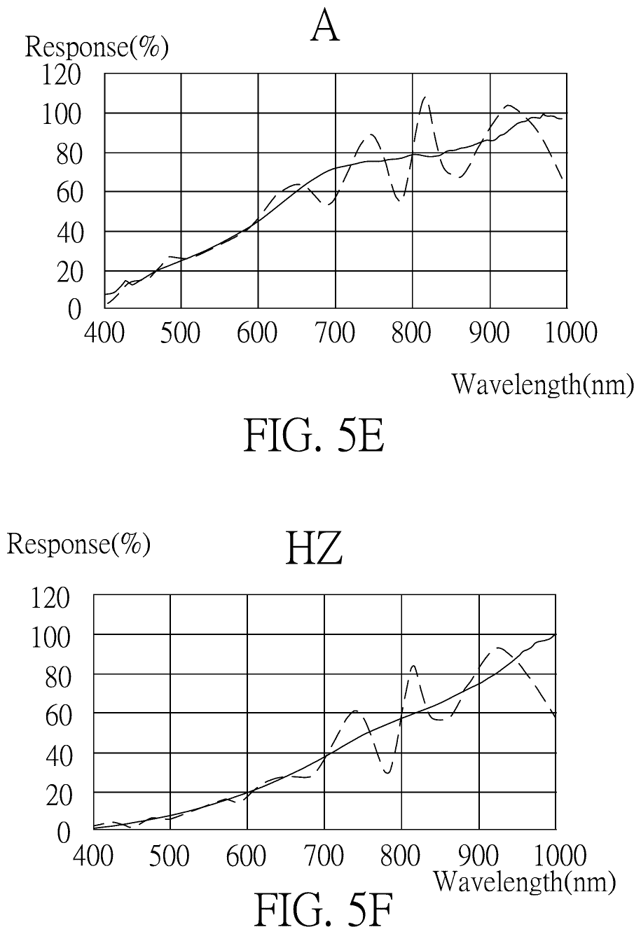

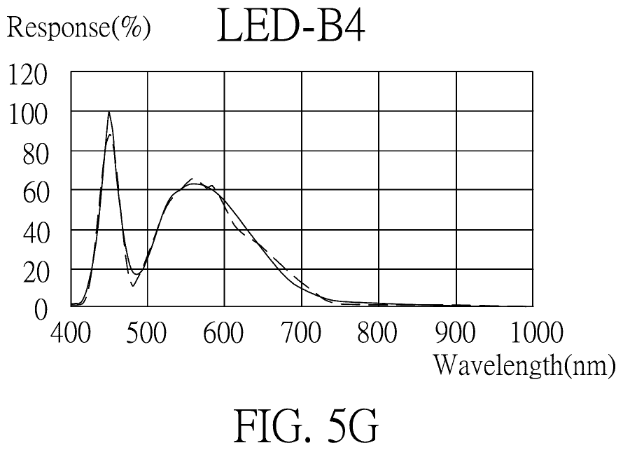

Please refer to FIG. 5A to FIG. 5G, which show the spectral reproduction results of the ambient light sensor for the seven standard test light sources according to the first embodiment of the present application, such as CWF, U35, U30, D65, A, HZ, and LED-B4. The solid lines are used to represent the actual light intensity emitted by these standard test light sources, while the dashed lines are used to represent the spectrum characteristic curves reproduced by merging the light intensity responses of a plurality of channel sensing units. It should be noted that compared to the spectral reproduction results of the existing ambient light sensor 9 for the same standard test light source as shown in FIG. 2A to FIG. 2G, although the ambient light sensor according to the first embodiment of the present application uses an absorptive filter made of materials such as photoresist materials as each of the filters 11 of the at least three main channel sensing units 1, it may still be used to sense and reproduce the spectral characteristic curves for distinguishing and identifying ambient light sources. If the Root Mean Square Error (RMSE) of the spectrum characteristic curves reproduced by the ambient light sensor according to the first embodiment of the present application for each standard test light source is calculated with the actual light intensity curves, the result of the RMSE is approximately 1.34.

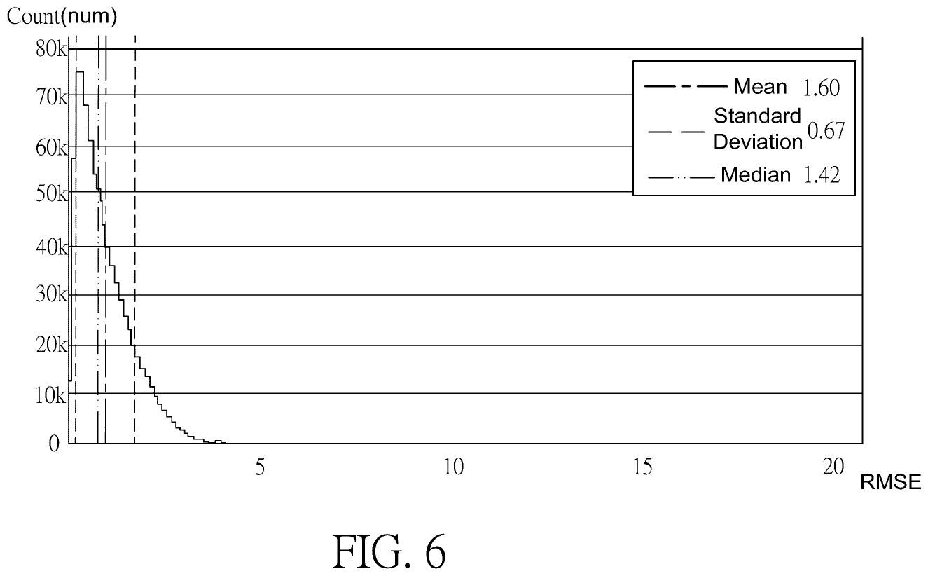

However, the significant improvement of the present application compared to the prior art is based on the fact that, since the filter 11 of the at least three main channel sensing units 1 is not formed by an interference filter, during production, there is no situation where the wavelength shift of the spectral response or the intensity shift of the light transmittance is easily caused by the thickness variation of the interference film. Even if using an absorptive filter made of materials such as photoresist materials, there will still be process variations such as coating thickness, but it will only cause variations in light transmittance (because the wavelength of the spectral response is determined by the characteristics of the material itself), and these variations are easy to calibrate in a subsequent process. Based on this, assuming that the spectral response of the interference filter has a wavelength response shift of ±5 nm and a light transmittance shift of ±5% (which only affects the at least one cooperative channel sensing unit 2 in the first embodiment), simulations are executed with a production volume of 1 million units, and the RMSE distribution results may be obtained as shown in FIG. 6. The average value of the RMSE remains at 1.6, which is a small difference compared to 1.34, the RMSE estimated in the original design, and the standard deviation also falls within an acceptable range, ensuring that the yield of the ambient light sensor produced according to this design is higher than the ambient light sensor according to the prior art.

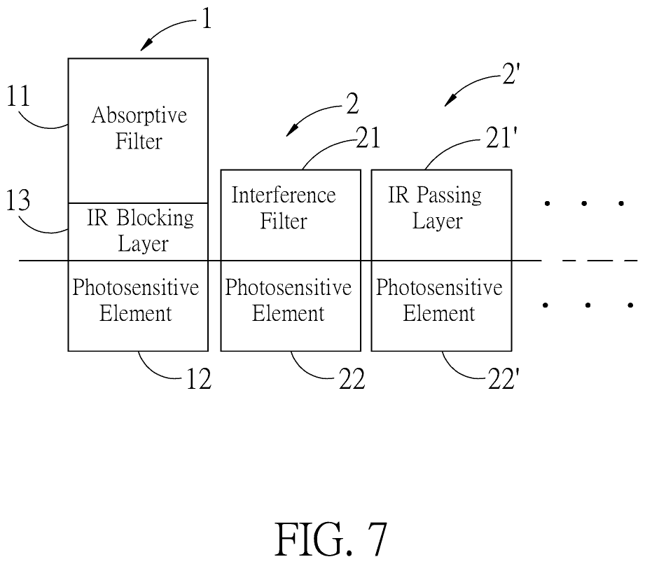

If the impact of the interference filter is required to be further reduced, please refer to FIG. 7. The two infrared light channels (approximately 766 nm and approximately 800 nm) included in at least one cooperative channel sensing unit 2′ of the ambient light sensor in the first embodiment may also each be formed by using an absorptive filter as its filter 21′. For example, materials such as a black photoresist capable of absorbing light within the visible light range may be combined with one of infrared light absorbing materials or infrared light absorbing layers for a specific wavelength band, and an infrared light passing layer (IR Pass Filter) may be formed as the filter 21′ to allow infrared light within a specific wavelength range to pass through there, which may replace the interference filters to form the two infrared light channels (corresponding to approximately 766 nm and approximately 800 nm). Under these improved conditions, the process variations in the interference filter will only affect the channel corresponding to the visible light range (such as the visible light channel corresponding to approximately 453 nm) contained in the at least one cooperative channel sensing unit 2, thereby, the yield of the ambient light sensor in the first embodiment of the present application is further improved during mass production.

It should be noted that the number and band design of the at least one cooperative channel sensing unit 2 are designed according to the actual needs of the user. For example, if improvement of the recognition accuracy for standard test light sources such as CWF, U35, U30, D65, A, HZ, and LED-B4 is necessary, in the ambient light sensor of the second embodiment of the present application, the at least one cooperative channel sensing unit 2 may include two visible light channels corresponding to approximately 453 nm and approximately 569 nm, and three infrared light channels corresponding to approximately 733 nm, approximately 777 nm, and approximately 794 nm. The five channels each may be formed by using an interference filter, or the two visible light channels corresponding to approximately 453 nm and approximately 569 nm may be formed by using an interference filter while the three infrared light channels corresponding to approximately 733 nm, approximately 777 nm, and approximately 794 nm may be formed by using the aforementioned infrared light passing layer.

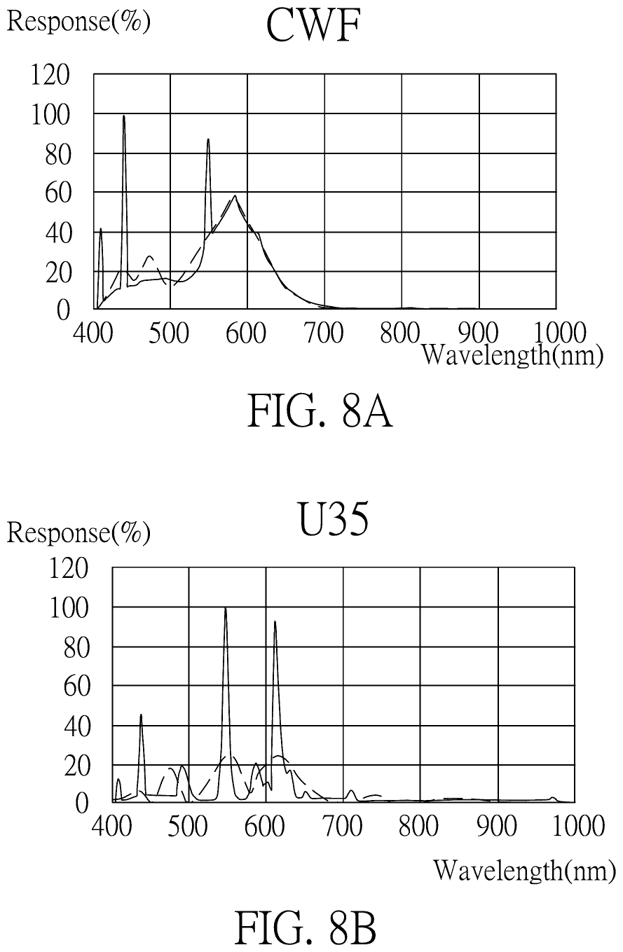

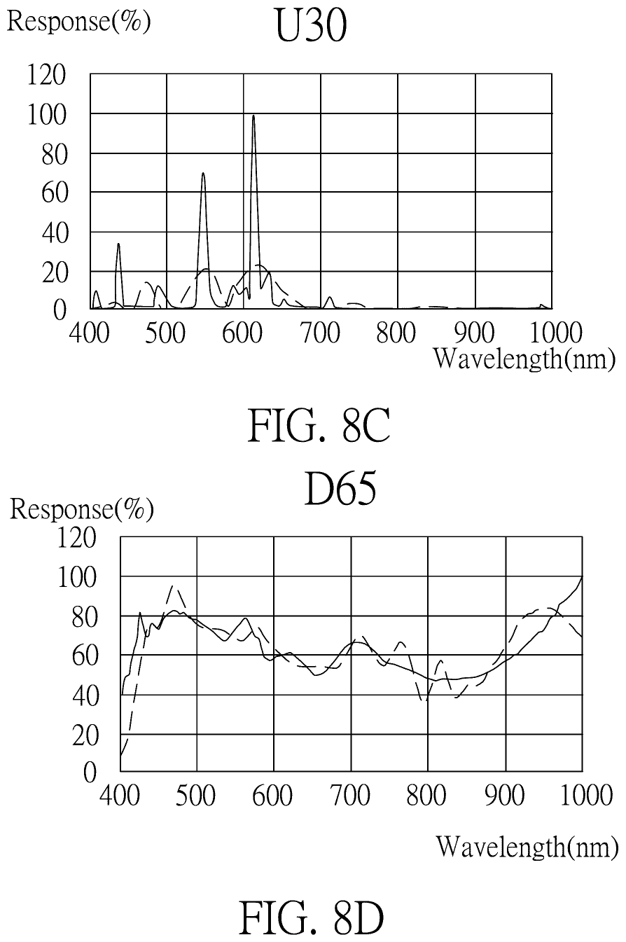

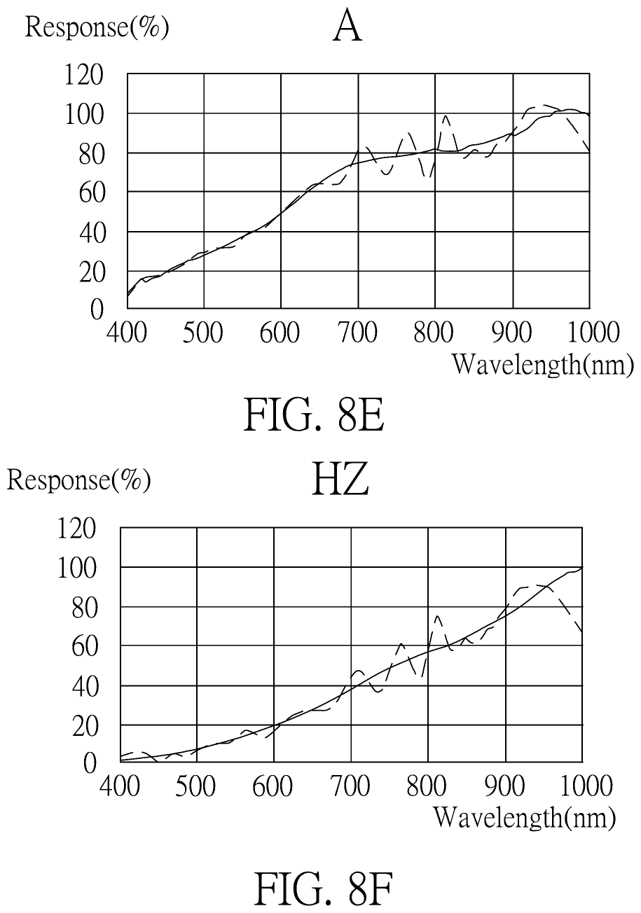

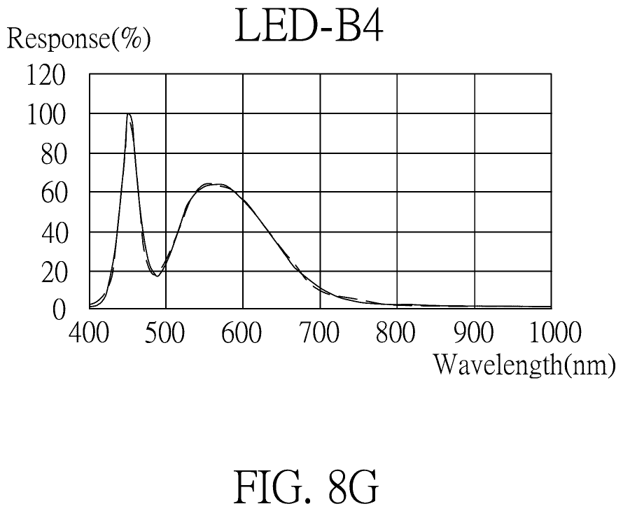

In the second embodiment, the ambient light sensor enhances the resolution of the at least three main channel sensing units 1 in the two visible light bands corresponding to approximately 453 nm and approximately 569 nm, and the infrared light bands corresponding to approximately 733 nm, approximately 777 nm, and approximately 794 nm, and achieves the spectral reproduction results for standard test light sources such as CWF, U35, U30, D65, A, HZ, and LED-B4, as shown in FIG. 8A to FIG. 8G. The solid lines are used to represent the actual light intensity emitted by these standard light sources while the dashed lines are used to represent the spectral characteristic curves reproduced by merging the light intensity responses of the plurality of channel sensing units. It should be noted that, compared to the spectral reproduction results of the prior art ambient light sensor 9 for the same standard test light source as shown in FIG. 2A to FIG. 2G, or compared to the spectral reproduction results of the ambient light sensor according to the first embodiment of the present application for the same standard test light source shown in FIG. 5A to FIG. 5G, the spectral reproduction results of the ambient light sensor according to the second embodiment of the present application clearly closely match the actual light intensity curves, and the spectral reproduction results which help to distinguish and identify the spectral characteristic curves of the ambient light sources. If the RMSE of the ambient light sensor according to the second embodiment of the present application is calculated between the spectral characteristic curves reproduced under various standard test light sources and the actual light intensity curves, the RMSE result is only approximately 0.74.

As may be seen from the second embodiment, increasing the number of the at least one cooperative channel sensing unit 2 directly benefits the performance of the ambient light sensor, nevertheless, also increases the overall design and production cost of the ambient light sensor, thereby, increasing the number of the at least one cooperative channel sensing unit 2 must be determined according to the user's needs.

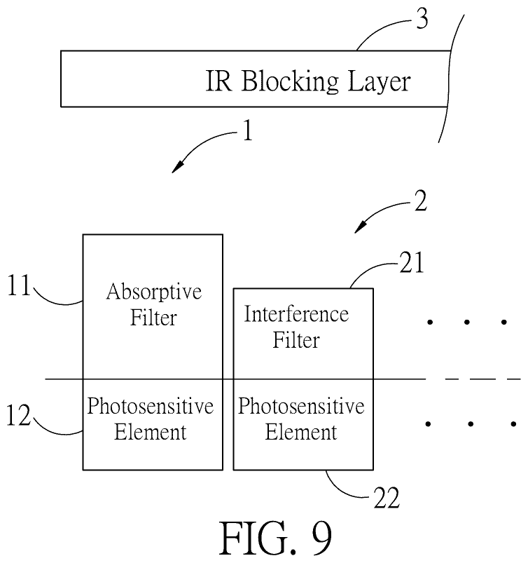

Under the scope of the foregoing embodiments of the present application, the following describes several variations, all of which are still within the claim scope of the present application:
First, using the ambient light sensor to reproduce the spectral characteristics approximate to the CIE XYZ color space may not only be used to determine the types of light sources; moreover, even if it is used to determine the type of light source, it is not necessary to simultaneously determine the aforementioned seven standard light sources. In the above embodiments, when the filters 11 of the at least three main channel sensing units 1 each is used as an absorptive filter, it is usually combined with an infrared light blocking layer 13 to filter out the component of infrared light. However, as shown in FIG. 9, when the ambient light sensor does not need to sense the component of infrared light in a specific application, the infrared light blocking layer 3 may also be designed to cover the at least three main channel sensing units 1 and the at least one cooperative channel sensing unit 2. Proceeding in this way, the at least three main channel sensing units 1 only need absorptive filters formed therein during manufacturing, and even if the at least one cooperative channel sensing unit 2 is an interference filter, no need is necessary to consider how to filter out the unwanted component of infrared light during design, which helps to simplify the overall design cost and reduce the process variability.

On the other hand, although the above embodiments highlight the good suppression effect of using absorptive filters for the at least three main channel sensing units 1 on the influence of process variation, however, if the user may actually accept a higher influence of process variation (which is usually present in simpler product applications), then not all filters 11 of the at least three main channel sensing units 1 need to be formed by using absorptive filters. In some embodiments of the present application, only two of the at least three main channel sensing units 1 may use two absorptive filters to form as two of the filters 11, and even under extreme conditions, only one of the at least three main channel sensing units 1 may use an absorptive filter to form as the filter 11.

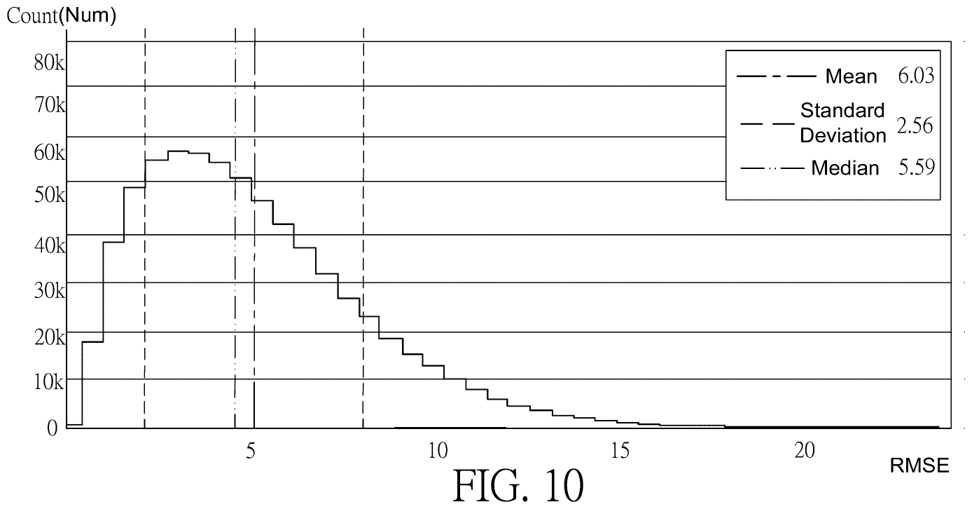

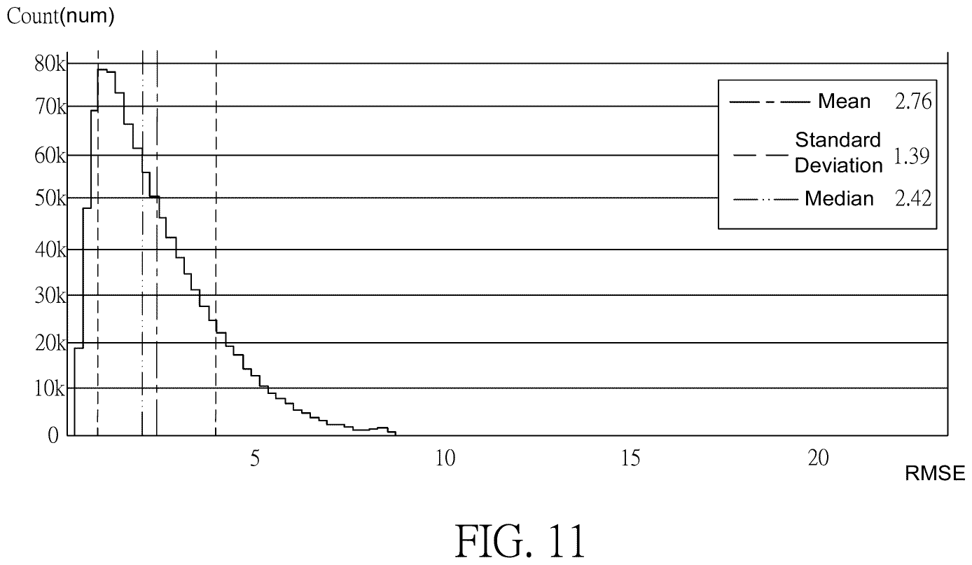

In addition, the ±5 nm wavelength response shift and ±5% light transmittance shift contained in the spectral response of the interference filter are only the simulation conditions initially set by the applicant. In practice, the shifts vary depending on the manufacturer's technical capabilities and the process costs. However, what is certain is that the higher the variability of the interference filter is, the more obvious the value of the ambient light sensor in each embodiment of the present application becomes. For example, comparing the aforementioned existing ambient light sensor 9 with the ambient light sensor according to the aforementioned first embodiment of the present application, when the spectral response of the interference filter has a ±10 nm wavelength response shift and a ±10% light transmittance shift, and simulating with a production volume of 1 million units, the existing ambient light sensor 9 may obtain the RMSE distribution result as shown in FIG. 10, while the ambient light sensor according to the aforementioned first embodiment of the present application may obtain the RMSE distribution result as shown in FIG. 11. The existing ambient light sensor 9 is completely unable to be produced normally under such severe process variations of the interference filter. In contrast, the ambient light sensor according to the aforementioned first embodiment of the present application may still be produced as products with errors within a controllable range even under the such severe process variations of the interference filter. The technical effect brought by using the absorptive filters in the at least three main channel sensing units 1 of the various embodiments of the present application is obvious, and it can be seen clearly that the application of the ambient light sensor embodiments of the present application has higher market value.

In summary, the ambient light sensing method and ambient light sensor according to the present application may only require appropriately configuring the absorptive filter(s) as the filter(s) of the at least three main channel sensing units to effectively control the error range of the spectral reproduction result of the ambient light sensor product affected by process variation. Compared with the prior art, it may indeed improve the product yield. Specifically, under the lower process variation conditions (±5 nm wavelength shift and ±5% light transmittance shift), the RMSE of the existing ambient light sensor of the prior art deteriorates significantly from the design value of 2.22 to an average value of more than 3.5, while the ambient light sensor according to the first embodiment of the present application only increases slightly from 1.34 to 1.6, and the error control capability according to the present application is significantly better than the error control capability according to the prior art.

Regarding process stability, the core advantage according to the present application lies in the fact that the spectral response wavelength of the absorptive filter is determined by the inherent properties of the material itself, is not affected by variations in film thickness, and only produces easily calibrated variations in light transmittance. This design significantly reduces the dependence on high-precision interference film processes and effectively controls the impact range of process variations on product performance. Compared to existing technologies that require strict control of the thickness parameters of multilayer films, the present application significantly simplifies process requirements and lowers the technical threshold for mass production.

From an industrial application perspective, the technical value of the present application is even more prominent under stringent process conditions. When process variations expand to ±10 nm wavelength shift and ±10% light transmittance shift, the existing ambient light sensors are completely unable to maintain normal production, while the embodiments of the present application may still be produced as products with errors within a controllable range. This technical characteristic allows the ambient light sensors according to the present application to be adapted to manufacturers with different process capabilities, expanding the scope of feasible industrial applications. Since the at least three main channel sensing units use absorptive filters with relatively relaxed process requirements, the improvement in overall production yield directly translates into cost advantages, meeting the stringent cost control requirements of the light sensor industry. Based on a plurality of factors, such as process stability, cost control, and performance, the present application indeed possesses higher industrial applicability and excellent market competitiveness, providing a practical improvement solution for the development of ambient light sensor technology.

The above descriptions are merely preferred embodiments of the present application; any equivalent variations and modifications made within the scope of the patent application for the present application shall fall within the scope of the present application.

1. An ambient light sensor, comprising:
at least three main channel sensing units, each of the at least three main channel sensing units comprising a first filter and a first photosensitive element, the first filter disposed on a light-receiving path of the first photosensitive element, wherein the first filter of at least one of the at least three main channel sensing units is an absorptive filter; and
at least one cooperative channel sensing unit, the at least one cooperative channel sensing unit comprising a second filter and a second photosensitive element, the second filter disposed on a light-receiving path of the second photosensitive element, wherein the second filter of at least one of the at least one cooperative channel sensing unit is an interference filter.

2. The ambient light sensor of claim 1, wherein the first filter of each of the at least three main channel sensing units allows the respective first photosensitive element to sense a visible light within a wavelength range distinguished from another visible light within another wavelength range sensed by another first photosensitive element, and by combining an intensity sensing result of the visible light from the first photosensitive element of each of the at least three main channel sensing units and a sensing result from the second photosensitive element of the at least one cooperative channel sensing unit, a reproduced spectral characteristic is provided to be approximate to a CIE XYZ color space.

3. The ambient light sensor of claim 1, wherein the at least three main channel sensing units comprise two first filters of two of the at least three main channel sensing units that are absorptive filters.

4. The ambient light sensor of claim 1, wherein the at least three main channel sensing units comprise three first filters of three of the at least three main channel sensing units that are absorptive filters.

5. The ambient light sensor of claim 4, wherein the absorptive filters are formed by using photoresist materials.

6. The ambient light sensor of claim 1, wherein the interference filter is formed by alternatively stacking a plurality of layers of dielectric materials with different refractive indices.

7. The ambient light sensor of claim 1, wherein the at least one cooperative channel sensing unit comprises a cooperative channel sensing unit corresponding to the visible light range, and the second filter of the cooperative channel sensing unit corresponding to the visible light range is served as an interference filter.

8. The ambient light sensor of claim 1, wherein the at least one cooperative channel sensing unit comprises a cooperative channel sensing unit corresponding to the visible light range and a cooperative channel sensing unit corresponding to the infrared light range.

9. The ambient light sensor of claim 8, wherein in the at least one cooperative channel sensing unit, the second filter of the cooperative channel sensing unit corresponding to the visible light range is served as an interference filter, and the second filter of the cooperative channel sensing unit corresponding to the infrared light range is an absorptive filter.

10. The ambient light sensor of claim 8, wherein the absorptive filter of the cooperative channel sensing unit corresponding to the infrared light range comprises an infrared light passing layer, configured to pass infrared light within a certain wavelength range.

11. The ambient light sensor of claim 1, wherein each of the at least three main channel sensing units further comprises an infrared light blocking layer, which is disposed on the light-receiving path of the first photosensitive element.

12. The ambient light sensor of claim 1, further comprising an infrared light blocking layer, covering the at least three main channel sensing units and the at least one cooperative channel sensing unit.
